(19) United States
(12) Patent Application Publication
(10) Pub. No.: US 2005/0271089 A1
(43) Pub. Date: Dec. 8, 2005

(54) Tuneable laser

(75) Inventors: David James Robbins, Towcester (GB); Anthony James Holden, Brackley (GB); Nickolay Zakhleniuk, Colchester (GB)

Correspondence Address: LAHIVE & COCKFIELD, LLP., 28 STATE STREET, BOSTON, MA, 02109, US

(73) Assignee: BOOKHAM TECHNOLOGY, PLC, Abingdon (GB)

(21) Appl. No.: 10/514,670

(22) PCT Filed: May 15, 2003
(86) PCT No.: PCT/GB03/02111

§ 371 Date: Jul. 21, 2005

(30) Foreign Application Priority Data
May 15, 2002 (GB) 0211037.7
May 15, 2002 (GB) 0211038.5
May 15, 2002 (GB) 0211039.3

(51) Int. Cl. H01S 3/10

(52) U.S. Cl. 372/20

(57) ABSTRACT

A tuneable laser including; a light creating section to generate light, the light creating section including a waveguide, and a tuneable section in which there is a waveguide connected to the waveguide in the light creating section, characterised in that the tuneable section waveguide contains a plurality of quantum dots.

This invention relates to tuneable lasers and has particular reference to such tuneable lasers having a tuneable portion incorporating quantum dots.

### BACKGROUND TO THE INVENTION

In this specification the term “light” will be used in the sense that it is used in optical systems to mean not just visible light but also electromagnetic radiation having a wavelength between 800 nanometres (nm) and 3000 nm.

Single wavelength lasers are important for a number of applications in optical telecommunications and signal processing applications. These include multiple channel optical telecommunications networks using wavelength division multiplexing (WDM). Such networks can provide advanced features, such as wavelength routing, wavelength conversion, adding and dropping of channels and wavelength manipulation in much the same way as in time slot manipulation in time division multiplexed systems. Many of these systems operate in the C- and L-Bands in the range 1530 to 1600 nm.

Tuneable lasers for use in such optical communications systems, particularly in connection with the WDM telecommunication systems, are known. A known tuneable system comprises stacks of single wavelength distributed Bragg reflectors (DBR) lasers, which can be individually selected, or tuned over a narrow range, or by a wide tuning range tuneable laser that can be electronically driven to provide the wavelength required.

In all of these tuneable lasers, reliance is placed on altering the refractive index of the tuning element of the laser by an external action to enable different wavelengths of the laser to be selected to satisfy the necessary lasing conditions.

Three main methods of varying the refractive index have been proposed and used.

In one method, the free electron plasma effect can be used by free carrier injection, that is by passing an electric current through the tuning section. In such a laser it is not the actual flow of electrons as such through the material which causes the effect, rather it is the variation in the numbers of electrons present in the material which matters. The passage of the current is the way in which additional electrons are injected into the material. Such a laser has therefore to be constructed and adapted in a manner well known per se by having a low resistance so as to permit current to flow through the relevant part of the laser.

In a second method, the fundamental bandgap can be changed by thermal heating.

In a third method electro-refraction modification can be brought about using the electro-optic effect. In the latter case, an electrical field is established across the tuning section, which changes the refractive index of the section and thus alters the wavelength of the light as it passes through the tuning section. In such a case the structure of the tuning section is such that it has a high resistance to the passage of an electrical current in response to an applied voltage, so that a field is established rather than significant quantities of current flowing.

Each of the tuning systems has advantages and drawbacks. In particular the thermal tuning scheme is very slow, the current tuning scheme has its speed limited by thermal heating effects and the electro refraction scheme has limited bandwidth of modulation, and large output power variation as a function of wavelength.

Preferably all tuning should be fast, it should consume as little energy as possible and it should provide as broad wavelength tuning as possible, ideally covering the C- and the L-bands without the output power variation. In the current injection tuning mechanism, the refractive index is modified through the change of the electronic contribution to the dielectric function due to the presence of the electrons in the injection current. At the same time, the injected current creates Joule heating, which dissipates in the device active region. As a result of this, the real wavelength switching speed of the laser device will be determined by the relatively long characteristic time of the heat dissipation, rather than by the electric current switching speed. The thermal dissipation effects can be decreased through device optimisation but cannot be eliminated. The thermally induced bandgap change has similar limitations.

The use of the electro-optic effect relies on the applied voltage rather than injected current and avoids excess heating and long thermal time constants. However, the low refractive index change available in technologically suitable materials, e.g. GaAs and other III-V semiconductors, is the main obstacle to its practical utilisation.

The common feature of all the above effects is that they are based on the externally managed change of the material index of refraction (that is varying the total refractive index n of the material, where:
n=n₀+Δn (1)
and n₀ is the refractive index at the base temperature, zero field or zero current and Δn is the change in the refractive index) enabling different emission wavelengths of the laser to be selected in order to satisfy the necessary lasing conditions.

All designs of lasers, whether tuneable or not have to be based on suitable materials and the designs have to be a compromise between what the designer would want to do and the limitations of the available materials. Many of the objectives of the laser place on the designer mutually opposed requirements and in practise the designer has to trade off one property against another.

An example of such a trade off is in the thickness of the waveguide along which the majority of the light passes through the laser.

The tuning section waveguide confines the light vertically by having a layer of material with refractive index n₂ sandwiched between two layers of refractive index n_{1.} To guide the light n₁<n₂.

These layers also have electronic band gaps, E_{gn,} associated with the value of refractive index such that E_{g2}<E_{g1} where E_{g1} is the band gap of the material of the layer having refractive index n₁ and E_{g2} is the band gap of the material of the layer having refractive index n₂, and a potential well is formed for electrons which captures and holds them in the layer with refractive index n₂ when used in current injection tuning mode.

These bandgap energies E_{g1} and E_{g2} also have a corresponding bandgap wavelength λ_{g1} and λ_{g2}.

The wave-guide confines light horizontally by the addition of a rib, being a ridge of material with index n₁. The ridge may be further overgrown with one or more materials so as to provide a distributed Bragg reflector (DBR) grating. The refractive index of the overgrowth is n₃, and n₃<n₁<n₂. The ridge including its overgrowth is surrounded on either side and at the top by a material which has a much lower refractive index and which could, for example, be air. The light therefore prefers to travel beneath the rib and with its highest intensity in the higher refractive index n₂ layer. However, the mode will spread out and have its evanescent tail in both n₁ regions. In particular, the light beam will also sense via its evanescent tail the presence of the DBR grating in the waveguide (actually etched into the n₁ layer) and the combination of the values for n₁, n₂, n₃ and the structure of the gratings will determine how the reflected wavelength is selected to effect the tuning of the laser. Changing the properties of any of these layers will cause the selected wavelength to move (i.e. tune). However the largest amount of tuning will be achieved if the refractive index is changed where the beam intensity is highest, and this is in the n₂ layer.

It is the layer with refractive index n₂ that is concentrated on by the present invention for all the tuning mechanisms discussed. It is into this layer that current is injected or a field applied depending on whether current injection or electro-optic tuning is used. It is this layer that has to be optimised to maximise the differential refractive index change Δn when the current or field is applied.

In summary, therefore, the n₂ layer requires:
(i) A very high Δn to achieve wide band optical tuning;
(ii) Sufficient carrier or electron confinement to ensure requirement
(i) is achieved in an injection device;
(iii) Also in an injection device the layer n₂ has to be sufficiently conducting to allow the carriers to flow throughout the waveguide and influence the Δn;
(iv) The strength of the guide (defined below) needs to be such as to provide single mode operation of the guide and a good mode match to the gain section.
(v) The bandgap wavelength, λ_{g2}, needs to be sufficiently below the operating wavelength, λ, to avoid optical loss and parasitic lasing.

The strength of the waveguide (v) is expressed as:
v²=α² (2π/λ)²(n₂²−n₁²) (2)
where α is the half thickness of the layer n₂ and λ is the wavelength of the propagating light.

The mode size, that is to say the width of the propagating beam (the beam is typically a two dimensional gaussian like shape in the light intensity in the plane perpendicular to the direction of propagation and the width can be defined as the average distance from the peak intensity to that point (or ellipse in two dimensions) at which the intensity has fallen to half the peak value), in the guide varies with v. As v increases the mode size initially reduces to a minimum and then increases. Typically tuning sections are designed with waveguide strengths greater than at the mode size minimum. A weaker guide produces a smaller mode size and is also more likely only to support a single mode. Usually the design aims to match the mode size to that of the gain section, whilst trying to ensure that the tuning section waveguide supports only a single mode. In practice for known tuneable lasers the mode is adequately matched to the gain section at the expense of having multiple modes in the tuning section.

As can be seen from expression (2), the guide strength can be reduced by decreasing α, the half thickness of the layer and/or reducing n₂ towards n₁.

In a conventional tuning section reducing α reduces the amount of active material available, and hence reduces the permitted values of Δn, as the less actual material present the less amount of absolute variation that is possible, no matter how much relative variation occurs. Reducing n₂ also reduces Δn as discussed below.

Because of the requirement to maintain sufficient thickness of the waveguide material so as to provide sufficient Δn in a conventional tuning region, so as to permit the attainment of one objective, namely adequate tuning, it is not possible by means of the thickness of the waveguide material to reduce the guide strength sufficiently, which is required to achieve a second objective, namely single mode operation. In single mode operation the light beam passes down the waveguide in a single manner so that the light beam emerging is in exactly the same mode as the light beam entering. If the thickness of the high refractive index layer is increased the waveguide will allow light to propagate in several different modes (i.e. different solutions to the wave equation in the guide giving different beam paths and shapes). This is undesirable as the higher order modes have different properties and degrade performance when reflected back into the gain section.

To understand how the waveguide strength is linked to Δn consider the equations for Δn.

The total refractive index in the n₂ layer is:
n₂=n₀₂+Δn (3)
where n₀₂ is the refractive index without an applied field or injected current and Δn can be defined for the case of electro-optic tuning with field F as:
Δn=−n₀₂³/2(rF+sF²) (4)
where r is the linear and s is the quadratic electro-optic coefficient, and F is the applied field.
And for the case of injection tuning with injected current I as:
Δn=−n₀₂ [f(I)] (5)
where f(I) is a complex function of injected current I but increases monotonically with increasing I in the operating region of interest.

Note that in both cases Δn is strongly dependent on n₀₂ and to achieve adequate tuning at practical currents the very highest value of n₀₂ is necessary. In fact to ensure a maximised n₀₂ the bandgap wavelength λ_{g2} has to be kept as close to the operating wavelength λ for the laser as possible. However λ_{g2} can approach λ from below to be typically not less than 100 nm otherwise optical losses in the tuning section begin to rise and the tuning section starts to behave like a parasitic laser (since its band gap wavelength is now close to that of the gain section—it just looks like an extended gain section). Taking λ_{g2} too far below λ causes n₀₂ to fall dramatically and Δn is compromised.

The present invention is concerned with methods and structures which permit many of these compromises to be avoided, so as to permit greater optimisation of laser design.

In recent years a great deal of interest has been shown, both theoretically and practically, in quantum well, quantum wire, and quantum dot containing materials. However, there is as yet no universally accepted and adopted nomenclature for these types of materials, for example these types of materials are sometimes referred to as low dimensional carrier confinement materials and other terms are also used. For clarity, therefore, in this specification there will be used three defined terms: quantum wells, which will be referred to as QWs; quantum wires; and quantum dots, which will be referred to as QDs.

In this specification the term QW is used to mean a material having a layer of narrow bandgap material sandwiched between layers of wide bandgap material, with the layer of the narrow bandgap material having a thickness dₓ of the order of the de Broglie wavelength λ_{dB} and the other two dimensions d_{y} and d_{z} of the layer of narrow bandgap material being very much greater than λ_{dB}. Within such a structure, the electrons are constrained in the x dimension but are free to move in the y and z dimensions. Typically for a III-V As based materials the thickness of the layer for a QW material would be in the range ˜50 Å to ˜300 Å.

If now the thickness of the layer dₓ is reduced to a minimum to give the QW effect, then there is only room in the QW for one energy level for the electrons. An overall QW may have some regions of one energy level only and some regions of a few energy levels.

If the QW is now considered as having a second dimension, say d_{y}, cut down to the size ˜λ_{dB}, so that both dₓ and d_{y} are ˜λ_{dB} and only d_{z} is very much greater than λ_{dB}, then the electrons are constrained in two dimension and thus there is, in effect, created a line in which the electrons can freely move in one dimension only, and this is referred to herein as a quantum wire.

If now the quantum wire is further constrained so that d_{z} is also ˜λ_{dB}, then the electrons are constrained within a very small volume and have zero dimension to move in. This is called herein a quantum dot (QD).

Thus if dₓ, d_{y}, and d_{z} are all very much greater than λ_{dB} the material is simply considered as a bulk material with no quantum effects of the type discussed herein. If dₓ˜λ_{dB} there is provided a quantum well, QW. If dₓ, d_{y}˜λ_{dB}, there is provided a quantum wire, and if dₓ, d_{y}, and d_{z}˜λ_{dB}, then there is provided a quantum dot, QD.

The technology for producing QWs is well known but quantum wires have yet to be produced on a commercial scale. In practise they have been formed in the laboratory by electrically constraining a QW structure with electrical fields or by so-called V-growth, but these are not yet a practical commercially available processes.

The present invention is concerned with the use and application of QD materials in current injection and or electro-optic tuneable lasers. Production processes for QD materials are well established. Two main processes have been developed, chemical etching and self-assembly, and the self-assembly process will be explained in more detail below.

QD materials have been widely suggested for use in lasers, see for example D Bimberg et al, Novel Infrared Quantum Dot Lasers: Theory and Reality, phys. stat. sol. (b) 224, No. 3, 787-796 (2001). Principally they have been suggested for use in the light creating lasing section of a current injection laser because they can produce light of a very narrowly defined wavelength, with a very low threshold current and QD materials have a very high characteristic temperature so as to give a temperature stable laser emitter. Because of these very significant benefits, most of the work on QD materials in laser applications has concentrated on their use in the emitter.

QDs are little boxes of narrow bandgap material formed inside the bulk semi-conductor material. They confine the weakly bound electrons and their corresponding holes (in the valence band) and do not allow them to conduct. They are, in essence, artificial atoms.

### APPLICATIONS OF THE INVENTION

The present invention is not directed to the use of QD materials in laser emitters, but is directed to the use of QD materials in the tuning or phase sections of the laser.

### BRIEF DESCRIPTION OF THE INVENTION

By the present invention there is provided a tuneable laser including; a light creating section to generate light, the light creating section having a waveguide, and a tuneable section in which there is a waveguide connected to the waveguide in the light creating section, characterised in that the tuneable section contains a plurality of quantum dots.

The laser may be tuned by current injection utilising the free plasma effect and the quantum dots may have enhanced tuning properties compared to the material of the waveguide surrounding the quantum dots.

The laser may be tuned by electro-optic modification of the refractive index of the material in the waveguide and the quantum dots may enhance the electro-optical effect within the waveguide.

The tuneable section may be the tuning section of the laser, and may incorporate a distributed Bragg reflector.

The tuneable laser may incorporate a phase change section and the phase change section may be a tuneable section.

The semiconductor material may be a III-V semiconductor material, which may be based on a system selected from the group GaAs based, InAs based materials and InP based materials.

The laser may comprise a combination of gain sections, phase sections and tuning sections and thereby be a three or four section laser, or have more than four sections.

The quantum dots are self-assembled quantum dots in which the self-assembled quantum dots may be formed of InAs based material in host GaAs based semiconductor material. The host material may be formed on a GaAs substrate.

The self-assembled quantum dots may be formed of InGaAs based material in host GaAs based semiconductor material which host material may be formed on a GaAs substrate.

The self-assembled quantum dots may be formed of InAs based material in host InGaAsP based semiconductor material which host material may be formed on an InP substrate.

The self-assembled quantum dots may be formed of InGaAs based material in host InGaAsP based semiconductor material which host material may be formed on an InP substrate.

Alternatively, the quantum dots may be formed by a chemical etching process.

There may be a plurality of layers of quantum dots.

The present invention further provides a tuneable laser including; a light creating section to generate light, a tuneable section and a phase change section, the tuneable section and the phase change sections having waveguides connected to the waveguide of the light creating section, characterised in that the waveguide of the phase change section contains a plurality of quantum dots.

The present invention further provides in a tuneable laser including; a gain section having a waveguide, a tuneable section having a waveguide and optionally a phase change section having a waveguide, the material of the waveguide of the tuning section having a refractive index n, which has a fixed background part n₀ and a part Δn which is variable under an external influence, whereby the amount of variation Δn is a function of the value of the external influence, the improvement which comprises decoupling the value of Δn from n₀ by incorporating quantum dots into the waveguide.

The external influence may be selected from the group, heat, injected current or applied field.

A method of operating a tuneable laser as set out above in which the laser has a forward bias with the p-layer of the laser connected positively and the n-layer connected negatively.

A method of operating a tuneable laser as set out above in which the laser has a reverse bias with the p-layer of the laser connected negatively and the n-layer connected positively.

### DESCRIPTION OF THE PREFERRED EMBODIMENTS OF THE INVENTION

The present invention will now be described with reference to the accompanying drawings, of which:—

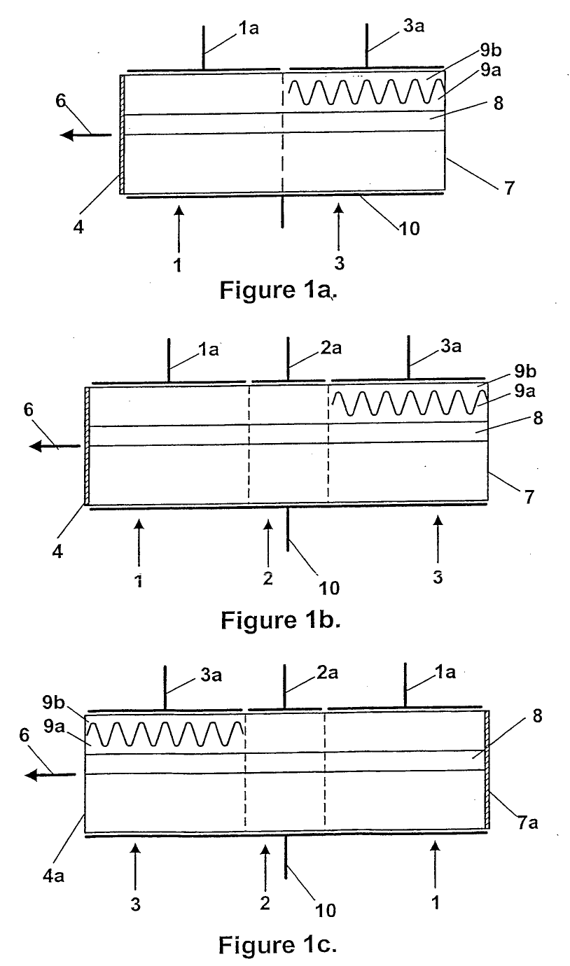

FIG. 1a. is a schematic cross section of a two section tuneable laser

FIG. 1b. is a schematic cross section of a three section tuneable laser,

FIG. 1c. is a schematic cross section of an alternative three section tuneable laser,

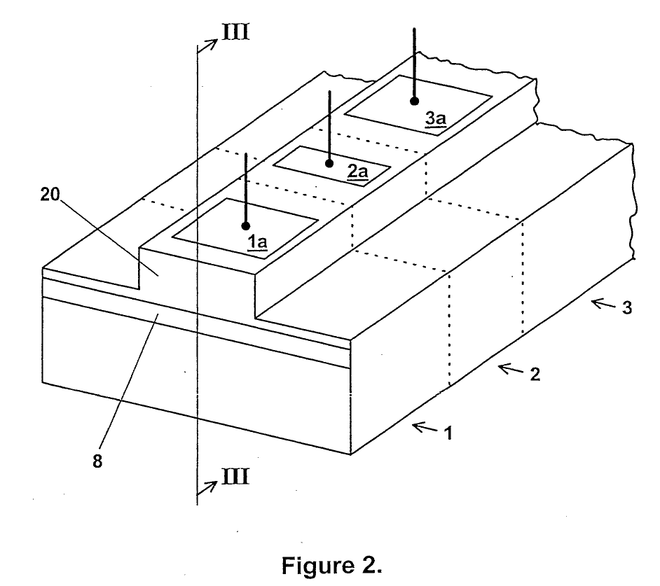

FIG. 2. is a perspective view of the laser of FIG. 1b.,

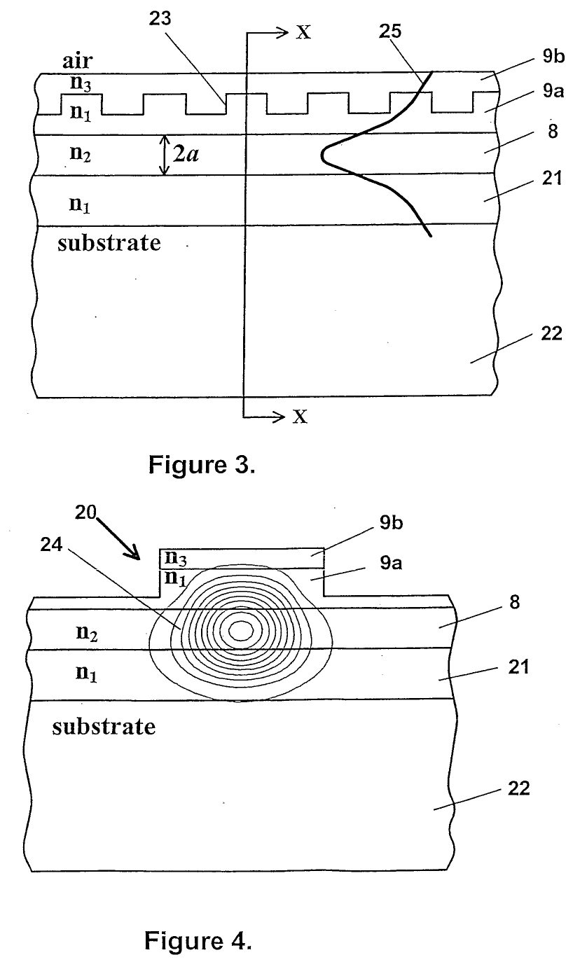

FIG. 3. is a sectional view of FIG. 2. along the line III-III,

FIG. 4. is a sectional view of FIG. 3. along the line X-X,

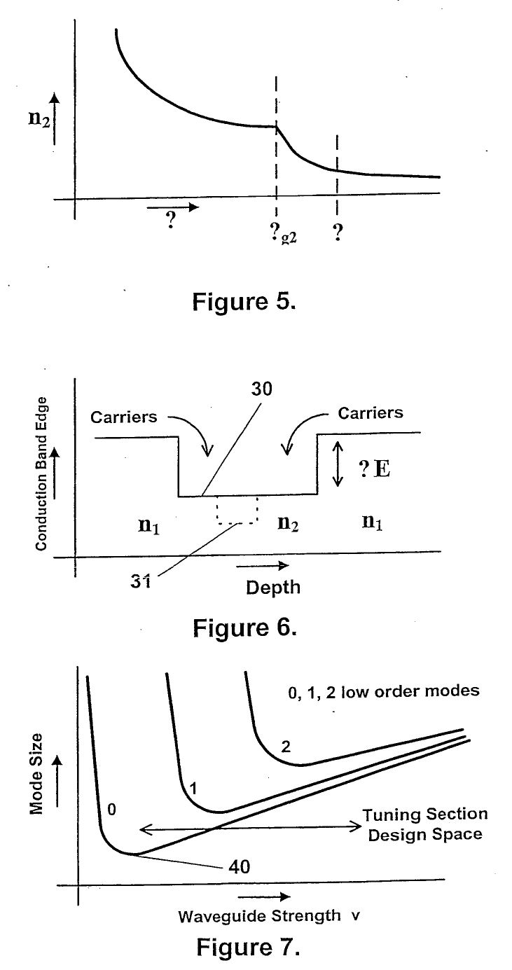

FIG. 5. is a graph of refractive index against wavelength FIG. 6. is a graph of conduction band edge profile against depth, and

FIG. 7. is a graph of mode size against waveguide strength.

Semiconductor tuneable lasers are known in the art. The principals of tuneable lasers are described in chapters 4 and 5 of “Tuneable Laser Diodes”, by Markus-Christian Amann and Jens Bus, ISBN 0-89006-963-8, published by Artech House, Inc.

Referring to FIG. 1a., this shows schematically in cross section a first embodiment two-section Distributed Bragg Reflector (DBR) tuneable laser.

The laser, which in this embodiment is a current injection laser, has a gain section 1, and a tuning section 3 incorporating a distributed Bragg reflector grating. At the front of the gain section on the opposite side to the tuning section is a partially reflecting mirror 4, which reflects at all operating wavelengths. The laser works by injecting current through an electrode 1a into the gain section 1 and through a common return electrode 10 to create the carrier population inversion and cause the gain section to emit light. This light is reflected by the tuning section 3, which reflects at the lasing wavelength, and by the mirror 4, so as to build up into laser light at the wavelength of the reflection from the distributed Bragg reflector grating, in a manner well known per se. The laser light is emitted from the front of the laser in the direction of the arrow 6. A common optical waveguide 8 formed of a material having a refractive index at zero current of n₀₂ operates across the whole longitudinal lasing cavity of the device. The rear facet 7 of the laser is anti-reflection coated so that it does not produce any secondary reflections, which would disturb the desired operation of the longitudinal lasing cavity formed between the tuning section and the front mirror 4. Typically a tap of laser light from the rear facet 7 may be used in wavelength locker applications.

The tuning section 3 contains a distributed Bragg reflector grating formed between a layer of material 9a of a refractive index n₁ and an upper layer of material 9b having a refractive index n₃ which is lower than the refractive index n₁ of the layer 9a. The refractive indices n₁ and n₃ are both lower than refractive index n₂. The distributed Bragg reflector grating itself is defined by the boundary between the two layers 9a and 9b. It is formed by laying down layer 9a upon waveguide layer 8, photo etching the layer 9a in the manner well known per se, for example using a photo-resist with electron beam writing techniques or phase mask holographic techniques as though it were any other material, and then laying down the upper layer 9b onto the layer 9a which has the distributed Bragg reflector grating interface etched into it.

The pitch, Λ, of the grating unit formed between layers 9a and 9b can be determined by the Bragg condition
λ=2n_{eff}Λ (6)
where λ is wavelength, n_{eff} is the effective refractive index of the waveguide material. In some cases, where the light “sees” a plurality of different materials on its passage through the laser, n_{eff} may not be exactly the same as n₁ or n₂. Λ is the pitch for first order gratings, which are preferred as they provide the strongest coupling.

As is well known, if a current is passed via electrode 3a, the effective refractive index of the grating and the active material immediately underneath the electrode is decreased and hence the wavelength at which the grating reflects can be current tuned.

The tuneable laser shown in FIG. 1a. is in the most basic form. A preferred embodiment is shown in FIG. 1b. Common integers have been used for equivalent functionality for all embodiments described.

FIG. 1b shows schematically in cross section a three-section DBR tuneable laser. The laser comprises a gain section 1, a phase change section 2 and a tuning section 3. At the front of the gain section on the opposite side to the phase change 2 is a partially reflecting mirror 4, which reflects at all operating wavelengths. The laser works by injecting current through an electrode 1a into the gain section 1 and through the common return electrode 10 to create the carrier population inversion and cause the gain section to emit light. This light is reflected by the tuning section 3, which reflects at the lasing wavelength, and by the partially reflecting mirror 4, so as to build up into laser light at the wavelength of the reflection from the distributed Bragg reflector grating. The laser light is emitted from the front of the laser in the direction of the arrow 6. The phase matching section 2 is used to maintain a constant longitudinal optical cavity length and thereby prevent mode hoping. The phase section has its own independent electrode 2a. Similarly, the tuning section 3 has its own independent electrode 3a.

Those of ordinary still will appreciate that the architecture of FIG. 1b., may be modified to an alternative preferred embodiment as shown in FIG. 1c., wherein the tuning section and gain section have been interchanged. In this architecture the rear facet 7a would be coated for high reflectivity to act as a mirror. In this arrangement the front mirror 4a would be designed for very high transmission and minimal reflectivity so that operationally the cavity defined by 4a and 7a, would be negated by the dynamics of the cavity defined by 7a and the tuning section 3. Each of the sections 1, 2 and 3 in this design has its own independent electrodes 1a, 2a and 3a respectively.

It will be appreciated that as well as two and three section longitudinal semiconductor tuneable lasers there are other classes of design such as the four-section laser discussed in GB2337135B. In the main these higher order tuneable laser design use alternative mirror arrangements in place of the front facet mirror. In so far as these alternative mirror arrangements rely upon the material refractive index to determine the operating wavelength, so this invention may be used with these higher order tuneable laser designs.

In a similar manner to the electrical drive of the tuning section, so the phase section can be electrically driven to make fine-tuning control.

The present invention also contemplates the use of a tuneable laser tuned by the electro-optic effect. The structure of the laser would look similar to that shown in FIGS. 1a. to 1c., except the common electrode 10 would be replaced with individual electrodes under the gain, phase and tuning sections with an electrical isolation barrier which was optically transparent but electrically non-conducting between the various sections. A suitable means of constructing such a barrier is given in “Ultra-Fast Optical Switching Operation of DBR Lasers using an Electro-Optical Tuning Section”; F Delorme, A Ramdane, B Rose, S Slempkes and H Nakajima; IEEE Photonics Technology Letters, Volume 7, No. 3, p. 269, March 1995.

It will be appreciated that, so far, no reference has been made to the tuning section containing QDs.

As mentioned above, QD structures effectively comprise a plurality of small, notionally zero dimension regions, in a host of bulk semiconductor material. These regions are capable of capturing and confining carriers (electrons and/or holes) as described in “Quantum Dot Heterostructures” by D. Bimberg, M. Grundmann and N. N. Ledentsov, published by Wiley, Chichester 1999, chapter 1. The mechanism of the enhanced electro-optic performance of the QDs is described below.

Two main methods of producing QD structures have been developed and are described in chapter 2 of the above reference. The first is to produce a flat relatively thick layer of bulk wide bandgap material and to deposit on it a thin layer of narrow bandgap material each of appropriately chosen lattice constant and bandgap. The thin layer of narrow bandgap material is then covered with a layer of photo-resist, and exposed to form a pattern of dots. The unwanted material is then chemically etched away and the photo-resist is then stripped off. Another thick layer of bulk material is applied and the process is repeated as often as is required.

A preferred alternative method for forming the QDs is however the self-assembly method (SAQDs) as described in chapter 4 the Bimberg, Grundmann and Ledentsov reference above. In this process a thin layer of, for example, InAs is grown rapidly onto a wetting layer on a thick bulk layer of, for example, GaAs. This can be done using either molecular beam epitaxy (MBE) or metal organic vapour phase epitaxy (MOVPE). MOVPE is also sometimes called metal organic chemical vapour deposition (MOCVD).

The amount of the InAs is so controlled as to exceed a critical thickness at which point the grown layer above the critical thickness layer splits into isolated dots as a consequence of the strain between the InAs and the GaAs, of our example, and the growth conditions. These dots can be further overgrown by a further layer of GaAs, and then further InAs dots grown as described. This can be repeated for a plurality of layers. This results in a plurality of layers of individual quantum dots (QD).

MOVPE can be used, as is known, to create QDs on an industrial scale. The QDs are self-assembling and typically contain a few thousand of atoms and are normally very flattened pyramids. The ratio of the pyramid base, d, to their height, h, is normally in the range of 5 to 100. Since they are self-assembling, the dimensions of each dot cannot be separately controlled however, it is known that the average size and density of dots can be controlled technologically and manufactured reproducibly.

Set out below is how such QDs can be used to enhance the effectiveness of a current injection tuneable laser in accordance with the invention. In a bulk semiconductor, the core electrons stay on the atoms of the crystal lattice, whilst the valence electrons go off free and become conduction electrons in the conduction band, if they attain an energy level sufficient to pass across the bandgap. These electrons are free to move throughout the material and provide electrical conduction.

All current injection tuneable lasers known to date exploit the free electron plasma effect in order to change the refractive index of the material in a tuning section. The effect takes place only if the electron gas has at least one degree of freedom for a free electron motion. In the case of the carriers confined in a quantum dot there is no degree of freedom at all due to complete localisation of the electrons within small volume. As a result there is no plasma effect in quantum dots as opposed to the case of bulk or quantum wells/wires. In consequence it would seem that current injection techniques could not be used to tune lasers which operate on the current injection principle.

However, at the same time, injection of additional electrons into the quantum dots will change the polarisability of the dots and therefore the refractive index of the material incorporating quantum dots. This is a completely novel way of modification of the refractive index of material with quantum dots. The advantage of the invention is that it should provide considerably larger change of the refractive index of the material under the same injection current as compared with present current tuneable lasers. Additionally, it is considered possible in principle to combine in a tuneable laser both contributions to the refractive index change due to the plasma effect and due to the incorporation of quantum dots. This is because the fraction of the injected carriers which are not captured (or “fall”) into the quantum dots will contribute to the refractive index change through the conventional plasma effect, and the fraction of the captured electrons will change the refractive index due to enhancement of the polarisability of the quantum dots as described above.

If current is injected into a semiconductor material having a refractive index of n₀ then the refractive index will change by an amount Δn to a new value n, where n=n₀+Δn. In the case of current injection with current I, Δn=n₀ [f(I)], where f is a complex function. However, in practice, f can be considered to be such a function that Δn increases with increase of I, but additionally, the value of Δn is such that Δn is very small compared to n₀.

Because Δn is small compared to n₀, any changes effected by varying the current injected are also small.

When light is passed through a material it interacts with the atoms forming the material and polarizes the atoms. The outcome of this interaction is defined by the refractive index, n₀, of the material. Further, the light sets up oscillating waves of free charges (electrons and holes). The frequency of such oscillating waves is known as the plasma frequency, ωₚ, of the material. ωₚ² is proportional to Nₑ₍ₚ₎, where Nₑ₍ₚ₎ is the free electron (hole) density within the material.

The above mentioned oscillating waves generate additional polarization of the material which in turn affects the propagation of the light through the material. The outcome of this interaction is defined by the additional contribution to the refractive index Δn of the material. Also Δn<<n₀ however, there is an important difference between Δn and n₀ in so far as, current injection influences Δn, but not n₀. It is this property which is used in current tuned tuneable lasers. Thus injecting more free electrons will result in change in Δn and therefore in the total refractive index of the material.

In a QD material the conduction electrons on atoms within a quantum dot cannot get away from the quantum dots, as they cannot attain sufficient energy to overcome the additional confinement energy of the quantum dot. The outer band electrons are confined to the dot and are not free to move through the host semiconductor material and provide electrical conduction. Effectively such QDs behave like large artificial atoms.

An important difference of this artificial atom, from the real atoms, is that in the former it is possible to change the number of electrons occupying outer shells of the atom by the process of electron injection as herewith described.

When an external current is passed through the structure of a semiconductor containing QDs, the injected electrons are captured by the QDs onto the outer shells. In a bulk material the light polarises the atoms by interacting with the core electrons, which are strongly bound to the nucleus of the atoms. In a QD additional electrons are not so strongly bound, as core electrons, to the dot. The dot is therefore a very highly polarisable artificial atom and Δn is increased. Since the polarisability of the artificial atom increases as a function of the number of electrons injected, Ne the greater the current the more electrons are injected and the greater the effect on Δn. This unique characteristic of quantum dots (QD) distinguishes them over all other bulk, quantum well or quantum wire semiconductor materials.

The above explanation has been given in the context of electrons being the free carriers, but there is an equivalent explanation for holes being the free carriers.

An injected current passing through the tuneable section of the laser will exploit the free plasma effect in the bulk (non QD material) in the conventional manner. However, the current will change the polarisation of the QDs, as described above, and thus increase the variation of the refractive index. Thus two effects will be occurring simultaneously.

Since, in absolute terms, ωₚ is very small compared to co the frequency of the light and the additional polarisability of the artificial atom (quantum dot) is small compared to the total polarisability of the solid semiconductor material, then Δn will be very small compared to n₀, thus as n_{eff}=n₀+Δn then n_{eff} will be very close to n₀.

This means that although QDs will significantly affect the amount of change in the refractive index of the material containing the QDs, their presence will not significantly affect the absolute value of the refractive index of the material containing the QDs.

It is well known that the bulk of the light passing through the tuneable laser is passing through the waveguide 8. The Bragg grating formed between layers 9a and 9b influences only the evanescent tail of the light beam passing through the laser. Thus it is possible to influence the light passing through the laser by incorporating QDs in either of the layers 9a or 9b or within the waveguide itself. Whichever layer has the QDs in it will have a significantly greater change of refractive index under the influence of injected current, so that the tuning effect, which relies on the overall change to the effective refractive index n_{eff} of the tuning section as a whole, is significantly increased by the provision of the QDs.

For maximum effect therefore we have discovered that the QDs should be placed in the region where the optical field is the strongest, in the waveguide, even though the reflecting element, the DBR is nearer the top of the waveguide.

We have also discovered that this applies whether the tuneable laser is a current tuned laser or a laser tuned by the application of an electric field so as to alter the refractive index of the waveguide by the electro-optical effect as described below.

In a semiconductor, the core electrons stay on the lattice, whilst the valence electrons go off into the conduction band and become conduction electrons if they attain an energy level sufficient to pass across the bandgap. These electrons are free to move throughout the material and provide electrical conduction.

In a QD material the conduction electrons on atoms within a quantum dot cannot get away from the quantum dots, as they cannot attain sufficient energy to overcome the additional confinement energy of the quantum dot. The outer band electrons are confined to the dot and are not free to move through the host semiconductor material and provide electrical conduction.

When an external field is applied to the structure of a semiconductor, the field distorts the atoms and it is this distortion that actually causes linear variation of the refractive index. In a bulk material the applied field has to interact with the valence electrons, which are strongly bound to the nucleus of the atoms, so the distortion is relatively small. However, in a QD the outer conduction electrons are locked into the dot. The QD behaves like an artificial atom. When an electric field is applied the conduction electrons confined within the QD behave like very loosely bound core electrons. The dot is therefore a very highly polarisable artificial atom.

As a consequence of the above the linear electro-optic effect within a QD layer is much greater than in bulk material, and this effect can also be used in accordance with the invention in the waveguide instead of current injection, in order to alter the refractive index of the material.

Referring to FIG. 2., this shows a perspective view of a schematic tuneable laser of the type illustrated in FIG. 1b. Common features have been given common reference numbers. The principal feature shown in FIG. 2., which is not readily apparent from FIGS. 1a. to 1c., is the rib 20, which has the effect of restraining the light in the waveguide 8 in the horizontal plane. In FIGS. 3. and 4. it will be seen that wave guide 8 is shown as being formed between layer 9a and layer 21, with the layer 21 being formed on a suitable substrate 22. The refractive index n₁ of the layer 21 would typically be the same as that of layer 9a and would always be lower than the refractive index n₂ of waveguide S.

Referring to FIG. 3., and as set out above, the distributed Bragg reflector grating 23 is formed between layers 9a and 9b and the light is constrained by the combined effect of the refractive indices of the layers 21, 8 and 9a and the presence of the rib 20, to the region 24 as shown in FIG. 4. The intensity of the light is greatest at the centre of the region 24 and the light intensity is shown graphically superimposed on the laser section at 25 in FIG. 3. The portion of the light within the layers 9a and 9b is conventionally referred to as the evanescent tail.

FIG. 5. shows schematically how the refractive index for a particular semiconductor alloy varies with wavelength in the tuning section, with the band gap wavelength defined as λ_{g2}. The wavelength of the incoming laser beam λ is determined by the gain section 1 of the laser. Typically for an InₓGa₁₋ₓAs_{y}P_{1-y} laser lasing at λ=1.55 μm the wavelength for λ_{g2} would be 1.42 μm (sufficiently far away from the lasing wavelength λ to reduce loss but near enough to maximise the differential change in refractive index with injected current or applied field. The latter follows directly from equations (4) and (5) by maximising n₀₂.

However, if quantum dots are used in the tuning section waveguide the wavelength λ_{g2} of the tuning section host material can be reduced to typically 1.15 μm because it is no longer necessary to keep the value of the refractive index n₀₂ very high to maximise the change in refractive index (Δn) with injected current or applied field—see equations (4) and (5). This is because the change of refractive index Δn is now dominated by the contribution from the quantum dots as described above, but decoupled from the background host material refractive index. The band gap wavelength λ_{g2} can therefore be reduced well below the operating wavelength λ thereby avoiding loss and parasitic lasing as discussed above. Also the corresponding refractive index in the waveguide layer (n₂) being reduced (and/or the layer (n₂) made thinner) can allow the waveguide to be designed with lower strength v. This will result in a smaller mode size and single mode behaviour. In both cases the value of the lasing wavelength λ would be 1.55 μm. As set out above, the waveguide 8 confines the light beam vertically by having a layer of material with refractive index n₂ sandwiched between two layers of refractive index n_{1.}

These layers also have electronic band gaps such that E_{g2}<E_{g1} and a potential well 30, of depth ΔE, is formed for electrons, which captures and holds them in the layer 8 with refractive index n₂ when used in current injection tuning mode as illustrated in FIG. 6. In the InGaAsP semiconductor alloy system, which is preferred for the manufacture of the tuning waveguide, the conduction band edge offset ΔE, as shown in FIG. 6., is defined by the difference in alloy composition in layer with refractive index n₁, and layer with refractive index n₂, and its value increases in proportion to the difference in refractive indicies, such that as n₂ reduces towards n₁ the value ΔE reduces towards zero. This well is two dimensional in nature and allows the electrons to move freely in the plane of the layer but not escape from the slab of material n₂. The depth of the well needs to be sufficient to ensure that the electrons are captured and “funnelled” along the layer to influence the refractive index as described above. A similar well exists for holes.

In optimising the tuning section waveguide it is preferred that the well depth ΔE is sufficient to confine the injected carriers and affect tuning. In this case the inclusion of quantum dots is also an advantage since the dots impose an additional well at the bottom of the confining well defined above (shown schematically in FIG. 6. as 31). This additional well is unaffected by the reduction in ΔE as n₂ reduces towards n₁ and hence will help to maintain the ability of the layer n₂ to capture and retain injected electrons.

The waveguide confines the light beam horizontally by the addition of a ridge 20 of material with index n₁ (and n₃ which is the index of the overgrowth layer 9b of InP on top of the grating 23 and n₃<n₁<n₂). The light therefore prefers to travel beneath the rib and with its highest intensity in the higher refractive index n₂ layer. However the light will spread out and have its evanescent tail in both n₁ regions. In particular the light beam will also sense the presence of the DBR grating on the top of the wave-guide (actually etched into the n₁ layer and shown schematically in FIG. 3.) and, as mentioned above, the combination of the values of n₁, n₂, n₃ and grating layers will determine how the reflected wavelength is selected to effect the tuning of the laser. Changing any of these parameters will cause the selected wavelength to move (i.e. tune). However, the strongest effect will be where the beam intensity is highest, and this is in the high refractive index n₂ material of layer 8, which has a thickness 2a.

It is this layer that is concentrated on by the invention for all the tuning mechanisms discussed. It is into this layer that current is injected or a field applied depending on whether current injection or electro-optic tuning is used. It is this layer that is optimised by the invention to maximise the differential refractive index change Δn when the current or field is applied. As described above it is this layer and the associated waveguide structure which has the five optimum requirements which have to be traded in known tuneable laser structures. After the foregoing discussion it is now possible to summarise how the inclusion of quantum dots in the tuning sections reduces or removes these compromises. Referring to the same numbered points as above, the n₂ layer needs:—
(i) A very high Δn to achieve wide band optical tuning—quantum dots enhance this by a factor of 6 or more as discussed below and do not depend on the refractive index of the host waveguide material.
(ii) Sufficient carrier or electron confinement to ensure requirement (i) is achieved in an injection device—quantum dots provide an additional confinement well which offsets the reduction in ΔE when n₂ is reduced towards n₁ (see (v) below).
(iii) Also in an injection device the layer n₂ has to be sufficiently conducting to allow the carriers to flow along the waveguide and influence the Δn—quantum dots help this by removing the constraint on the layer thickness since Δn is dominated by the dots not the host material.
(iv) The waveguide strength, v, needs to be such as to provide single mode operation of the guide and a good mode match to the gain section—quantum dots help this by dominating the value of Δn, allowing it to remain sufficiently high even when n₂ and/or the thickness of layer n₂ are changed to achieve a weaker waveguide.
(v) The bandgap wavelength, λ_{g2}, needs to be sufficiently below the operating wavelength, λ, to avoid optical loss and parasitic lasing—quantum dots help this by dominating the value of Δn independently of the host material refractive index n₀₂ allowing n₀₂ to be reduced by changing the alloy composition to move the host material bandgap wavelength λ_{g2} well below the operating wavelength λ of the laser.

FIG. 7. illustrates graphically the changing values of the mode size with variations in v as set out in equation (2) above and it can be seen that the mode size has a minimum at point 40. This graph is described in “An Introduction to Optical Waveguides”, by M. J. Adams, published by John. Wiley & Son, ISBN 0 471 27969 2. Typically most tuning sections are designed such that the waveguide strength v is greater than that at the minimum mode size point and so the mode size increases and decreases with increasing and decreasing waveguide strength.

In addition to the injection of electrons there is a mirror image injection of holes into the mirror image of the electron wells in the QDs. The holes also contribute to change of the refractive index in exactly the same way as described above for the case of electrons. The electrons and holes have to recombine to permit the passage of current and the recombination time τᵣ of the holes and the electrons is of the order of 10⁻⁹ to 10⁻¹⁰ seconds. The value for τᵣ for the QDs is about the same as τᵣ for bulk materials, and as τᵣ is short compared to the frequency at which the laser is retuned there is no problem in using the QDs in a fast reacting tuneable laser.

As set out above, the variation in the refractive index occasioned by an injection of a given amount of current into a QD layer, or by applying an electric field, is much greater than in bulk material. For example, in the case of electro-optic effect in InAs dots in GaAs the enhancement factor is typically 200 as described in the Journal of Vacuum Science and Technology, B 19 (4) 1455, 2001. Even though current technology permits a packing density such that only 3% of the volume of a structure can be formed of QDs, this still means that the overall increase in the polarisability is 3% of 200, i.e. about six times greater. The effect can be further enhanced by incorporating a plurality of quantum dot layers.

This means that compared to bulk material for the waveguide, a QD material would be typically six times or more effective in changing the refractive index compared to bulk semiconductor material operating with electro-optic tuning and not incorporating QDs, for the same external electric field applied. A similar enhancement of tuning performance might be expected for the case of current injection tuning.

In a practical application with a tuneable semiconductor laser such QD material used in the tuning section would allow the tunability to be increased to typically six times the wavelength range. This makes the invention a viable mechanism for tuning a semiconductor laser.

Use of an InP substrate for deposition of InAs quantum dots has been considered as one of the attractive methods in order to grow quantum dots in the gain or light creating and emitting section of a laser emitting at 1.55 nm, as described by A Pouchet, A Le Corre, H L'Haridon, B Lambert and A. Salaum, Applied Physics Letters No. 67, 1850 (1995).

The current tuneable lasers for 1.55 μm are also based on InP/InGaAsP material system. Therefore, it is very important from a practical point of view that quantum dots can also be incorporated into the tuneable section(s) of lasers based on the above materials. Although currently there is no experimental evidence to demonstrate growth of InAs quantum dots on the quarternary materials such as for example, InGaAsP, it is believed that there should not be any technological obstacles to realise such a growth. This is because the most important parameter for quantum dots growth is a lattice mismatch between InAs and InGaAsP. Since the InP layer is lattice matched to InGaAsP, this means that the lattice mismatch between InAs and InGaAsP is the same as between InAs and InP. Consequently, realisation of the quantum dots growth in the latter system means that they should also be capable of being grown in the former material system.

Table 1. below summarises the typical combinations that can be used for dots formed in an epitaxially grown host, which surrounds the quantum dots, on a given substrate.

TABLE 1

| Dot Material | Host Material | Substrate Material |
|---|---|---|
| InAs | GaAs | GaAs |
| InGaAs | GaAs | GaAs |
| InAs | InGaAsP (Quarternary) | InP |
| InGaAs | InGaAsP (Quarternary) | InP |

Present technology permits the creation of QDs using a wide range of III-V semiconductor materials. This permits the invention to be used in the tuneable section of lasers based on many otherwise unsuitable materials. The number of stacked layers is only limited by the technology available at the time of utilisation of the invention.

The invention thus permits high wavelength tuning speed, a wide tuning range, low energy consumption for switching operation and wavelength holding, substantial reduction of the Joule heating effect, as compared to conventional current injection tuneable lasers or thermally tuneable lasers or electro-optical effect tuneable lasers.

In the case of a current tuned laser, by including QD material in the tuning section of the laser, and using current to tune it, it is possible to get an increased tuning range beyond the 10 to 12 nm limit of non-QD material implementations, up to say 6 times the range. Alternatively, the current drive necessary to get the 10 to 12 nm tuning can be significantly lower, at say 1/6th the current required for non-QD containing materials. The benefit of the latter effect is that the lower amount of current required means less heating, which in turn means less power consumption, but more importantly less heat generation, so the change in wavelength response time will be much faster.

Embodiments of tuneable lasers in which QD material is used in the waveguide within the phase sections are possible. In such an embodiment the phase section can be very much shorter, because the refractive index change is much greater, and thus the optical losses through this section can be reduced.

Thus the invention contemplates a tuneable laser in which there is a phase change section and a tuneable section, and the quantum dots are provided in the waveguide of the phase change section only, not in the waveguide of the tuneable section. In practise, however, it is most probable that the quantum dots would either be included only in the waveguide of the tuneable section or in the waveguides of both the tuneable section and the phase change section, rather than in the waveguide of the phase change section alone.

Similarly, tuneable laser structures can be envisaged in which the QD material is used within the waveguide for all tuning sections and phase sections such as occur within four section, or higher order, tuneable lasers. QD material may also be used in the gain section of a tuneable laser as is known in the art for semiconductor lasers.

Further embodiments of the invention are possible wherein the Bragg grating is located in any part of the tuning section through which any part of the light passes, for example within the tuning waveguide itself.

1. A tuneable laser, comprising a light creating section to generate light, the light creating section including a waveguide, and a tuneable section in which there is a waveguide connected to the waveguide in the light creating section, wherein the tuneable section includes a plurality of quantum dots.

2. A tuneable laser as claimed in claim 1, wherein the plurality of quantum dots are located in the waveguide of the tuneable section.

3. A tuneable laser as claimed in claim 1, wherein the laser is tuned by current injection utilizing the free plasma effect and the plurality of quantum dots have enhanced polarisability compared to a material of the waveguide surrounding the quantum dots.

4. A tuneable laser as claimed in claim 1, wherein the laser is tuned by electro-modification of a refractive index of a material in one of the waveguides and the plurality of quantum dots enhance the electro-optical effect within the waveguide.

5. A tuneable laser as claimed in claim 1, wherein the tuneable section is a tuning section of the laser.

6. A tuneable laser as claimed in claim 5, wherein the tuneable section comprises a distributed Bragg reflector.

7. A tuneable laser as claimed in claim 6, wherein the distributed Bragg reflector is formed between two layers of different refractive indices and at least some quantum dots of the plurality of quantum dots are provided in one of the layers between which the Bragg grating is formed.

8. A tuneable laser as claimed in claim 1, wherein the tuneable laser incorporates a phase change section and the phase change section is a tuneable section.

9. A tuneable laser as claimed in claim 1, wherein at least one of the waveguides is formed of a III-V semiconductor material.

10. A tuneable laser as claimed in claim 9, wherein the III-V semiconductor material is based on a system selected from one of GaAs, InAs based materials and InP based materials.

11. A tuneable laser as claimed in claim 1, wherein the laser is a three or four section laser, or has more than four sections.

12. A tuneable laser as claimed in claim 1, wherein the plurality of quantum dots are self-assembled quantum dots.

13. A tuneable laser as claimed in claim 1, wherein any the self-assembled quantum dots are formed of an InAs based material in a host GaAs based semiconductor material.

14. A tuneable laser as claimed in claim 13, wherein the host material is formed on a GaAs substrate.

15. A tuneable laser as claimed in claim 12, wherein the self-assembled quantum dots are formed of an InGaAs based material in a host GaAs based semiconductor material.

16. A tuneable laser as claimed in claim 15, wherein the host material is formed on a GaAs substrate.

17. A tuneable laser as claimed in claim 12, wherein the self-assembled quantum dots are formed of an InAs based material in a host InGaAsP based semiconductor material.

18. A tuneable laser as claimed in claim 17, wherein the host material is formed on an InP substrate.

19. A tuneable laser as claimed claim 12, wherein the self-assembled quantum dots are formed of an InGaAs based material in a host InGaAsP based semiconductor material.

20. A tuneable laser as claimed in claim 19, wherein the host material is formed on an InP substrate.

21. A tuneable laser as claimed in claim 1, wherein the plurality of quantum dots are formed by a chemical etching process.

22. A tuneable laser as claimed in claim 1, further comprising a plurality of layers of quantum dots.

23. A tuneable laser, comprising a light creating section to generate light, a tuneable section and a phase change section, wherein the tuneable section and the phase change section have waveguides connected to a waveguide of the light creating section, wherein the waveguide of the phase change section includes a plurality of quantum dots.

24. In a tuneable laser, comprising a gain section having a waveguide, a tuneable section having a waveguide and a phase change section having a waveguide, wherein a material of the waveguide of the tuning section has a refractive index n, which has a fixed background part n₀ and a part Δn which is variable under an external influence, wherein the amount of variation Δn is a function of the value of the external influence, the improvement comprises decoupling the value of Δn from n₀ by incorporating quantum dots into the waveguide.

25. A tuneable laser as claimed in claim 24, wherein the external influence is one of heat, injected current or applied field.

26. A tuneable laser as claimed in claim 24, wherein the waveguide is a rib waveguide.
